(19) United States
(12) Patent Application Publication
(10) Pub. No.: US 2005/0284693 A1
(43) Pub. Date: Dec. 29, 2005

(54) Fall-protection system and related method

(75) Inventor: Thomas W. Rhodes, Newport Beach, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: T.W.R. Enterprises, Inc.

(21) Appl. No.: 10/880,288

(22) Filed: Jun. 28, 2004

(51) Int. Cl. A62B 1/16

(52) U.S. Cl. 182/3

(57) ABSTRACT

A fall-protection system configured to couple to a frame and a person. The fall-protection system including a first bracket-pole assembly, a second bracket-pole assembly, a cable, and a lanyard. The first and second bracket-pole assemblies are configured to couple to the frame. The cable is configured to couple between the first bracket-pole assembly and the second bracket-pole assembly. The lanyard has a first end that is configured to couple to the person and a second end that is configured to slidingly couple to the cable.

### BACKGROUND OF THE INVENTION

1. Field of the Invention

The invention relates generally to the field of fall-protection devices. More specifically, the invention relates to a fall-protection device for installation at a construction site.

2. Description of Related Art

Construction workers often are at risk of falling from a house that is under construction. During the construction process, construction workers often stand and work on top of wood frames. Since the top of the frame can be anywhere from approximately 8 feet to approximately 30 feet above the ground, there is high likelihood of a construction worker being injured as a result of a fall from the top of the frame.

One method way of minimizing the likelihood of a fall from the top of the frame is the use of scaffolding around the frame. However, scaffolding is expensive to purchase or rent, takes up large amounts of storage space when not in use, and is cumbersome and time consuming to install. Accordingly, there is a need for a less expensive, less massive, and less time consuming fall-protection system for use at construction sites. The present invention satisfies these needs.

### SUMMARY OF THE INVENTION

Embodiments of the present invention are included in a fall-protection system for use at a construction site that is low in cost, easy to install, and can be installed in a short amount of time. The fall-protection system is assembled at a construction site, and is used to prevent injury that could result from a construction worker's fall from the top of a frame structure that is under construction. The fall-protection system is configured to couple to a frame and to a person. The fall-protection system includes a first bracket-pole assembly, a second bracket-pole assembly, a cable, and a lanyard. The first and second bracket-pole assemblies are configured to couple to the frame. The cable is configured to couple between the first bracket-pole assembly and the second bracket-pole assembly. The lanyard has a first end that is configured to couple to the person and a second end that is configured to slidingly couple to the cable.

In other, more detailed features of the invention, each of the first bracket-pole assembly and the second bracket-pole assembly includes a bracket assembly and a pole assembly. The bracket assembly is configured to couple to the frame, and the pole assembly is configured to interface with the bracket assembly. The bracket assembly includes a bracket and a bracket tube. The bracket is configured to couple to the frame. The bracket tube is coupled to the bracket and is configured to interface with the pole assembly. The bracket is coupled to the frame using a fastening device selected from the group consisting of a screw and a nail. The bracket tube is welded to the bracket.

In other, more detailed features of the invention, the bracket assembly further includes a bracket strap having a first end that is configured to couple to the bracket, and a second end that is configured to couple to the frame. The bracket, bracket tube, and bracket strap are made of steel. The bracket strap is coupled to the frame and the bracket using fastening devices selected from the group consisting of screws and nails.

In other, more detailed features of the invention, the pole assembly includes a top pole, a bottom pole, and a sleeve. The top pole has a first end and a second end, the bottom pole has a first end and a second end, and the sleeve is configured to interface with both the top pole's first end and the bottom pole's first end. The sleeve is coupled to both the top pole and the bottom pole by a method selected from the group consisting of bonding, welding, screwing, and latching. The pole assembly further includes a cable-securing post that is coupled to the top pole's second end. The top pole, the bottom pole, the sleeve, and the cable-securing post are made of steel. The cable couples to the cable-securing post. The cable-securing post includes an interface piece configured to interface with the cable. The interface piece is selected from the group consisting of an eyelet, a hook, and a tube.

In other, more detailed features of the invention, the cable has a first end and a second end. The cable's first end includes a first loop, and the cable's second end includes a second loop. The cable's first and second ends are configured to interface with the interface piece.

In other, more detailed features of the invention, the cable has a first end and a second end. The first clip is coupled to the cable's first end, and a second clip is coupled to the cable's second end. Both the first clip and the second clip are configured to interface with the interface piece.

In other, more detailed features of the invention, the cable is made of steel. The fall-protection system additionally includes a harness configured to be worn by the person. The lanyard is coupled between the harness and the cable.

Another exemplary embodiment of the invention is a bracket-pole assembly configured to couple to a frame. The bracket-pole assembly includes a bracket assembly and a pole assembly. The bracket assembly includes a bracket and a bracket tube. The bracket is configured to couple to the frame. The bracket tube is coupled to the bracket. The pole assembly includes a top pole, a bottom pole, and a sleeve. The top pole has a first end and a second end. The bottom pole has a first end and a second end, where the bottom pole's second end is configured to interface with the bracket tube. The sleeve is configured to interface with both the top pole's first end and the bottom pole's first end.

In other, more detailed features of the invention, a bracket strap is configured to couple between the bracket and the frame. A cable-securing post is coupled to the top pole's second end and includes an interface piece.

An exemplary method according to the invention is a method for installing a fall-protection system on a frame and coupling a person to the fall-protection system. The method includes providing a first bracket assembly, providing a second bracket assembly, providing a first pole assembly having a first end and a second end, providing a second pole assembly having a first end and a second end, providing a cable, providing a lanyard having a first end and a second end, coupling the first bracket assembly to the frame, coupling the second bracket assembly to the frame, interfacing the first pole assembly's first end with the first bracket assembly, interfacing the second pole assembly's first end with the second bracket assembly, coupling the cable between the second ends of the first and second pole assemblies, coupling the lanyard's first end to the person, and coupling the lanyard's second end to the cable.

In other, more detailed features of the invention the first bracket assembly and the second bracket assembly each include a bracket strap having a first end and a second end, a bracket, and a bracket tube coupled to the bracket. The method also includes coupling the bracket to the frame, coupling the bracket strap's first end to the bracket, and coupling the bracket strap's second end to the frame.

In other, more detailed features of the invention, the first pole assembly and the second pole assembly each include a top pole, a bottom pole, and a sleeve having a first end and a second end. The method also includes coupling the sleeve's first end to the top pole, and coupling the sleeve's second end to the bottom pole.

Other features of the invention should become apparent from the following description of the preferred embodiments taken in conjunction with the accompanying drawings, which illustrate, by way of example, the principles of the invention.

### BRIEF DESCRIPTION OF THE DRAWINGS

FIG. 1 is an elevational view of one embodiment of a fall-protection system according to the present invention installed on top of a frame.

FIG. 2 is an elevational view of the protection system of FIG. 1 including a construction worker suspended from the fall-protection system.

FIG. 3 is an elevational view of a bracket-pole assembly included in the fall-protection system of FIG. 1.

FIG. 4 is a perspective view of a bracket assembly included in the fall-protection system of FIG. 1.

FIG. 5 is a perspective view of a bracket-pole assembly included in an additional embodiment of the fall-protection system of FIG. 1.

### DETAILED DESCRIPTION OF THE PREFERRED EMBODIMENTS

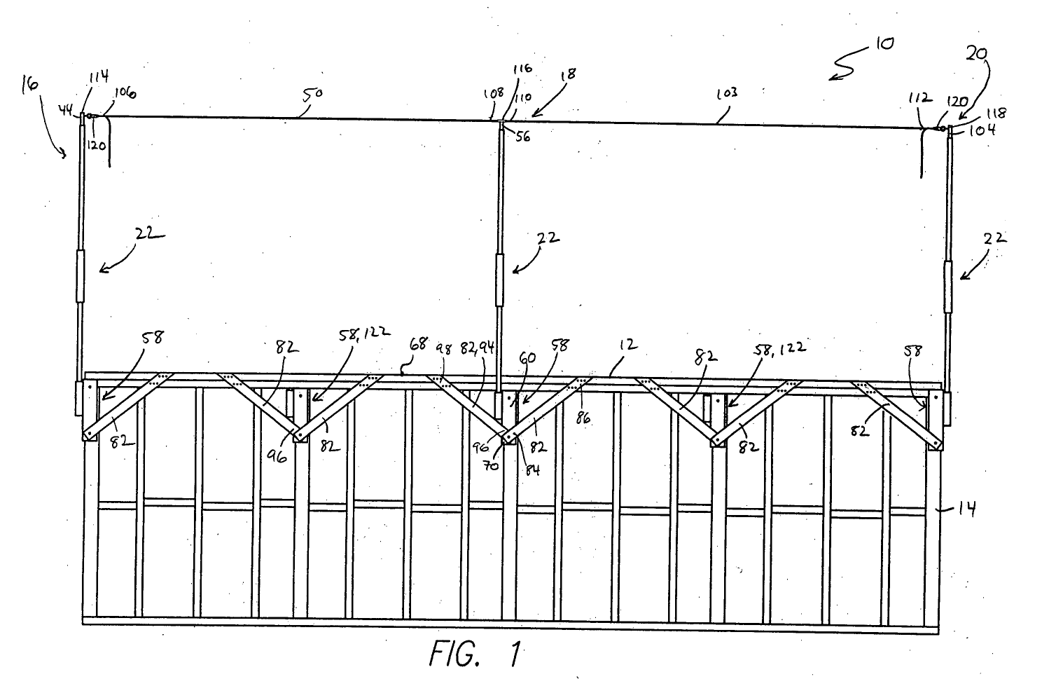

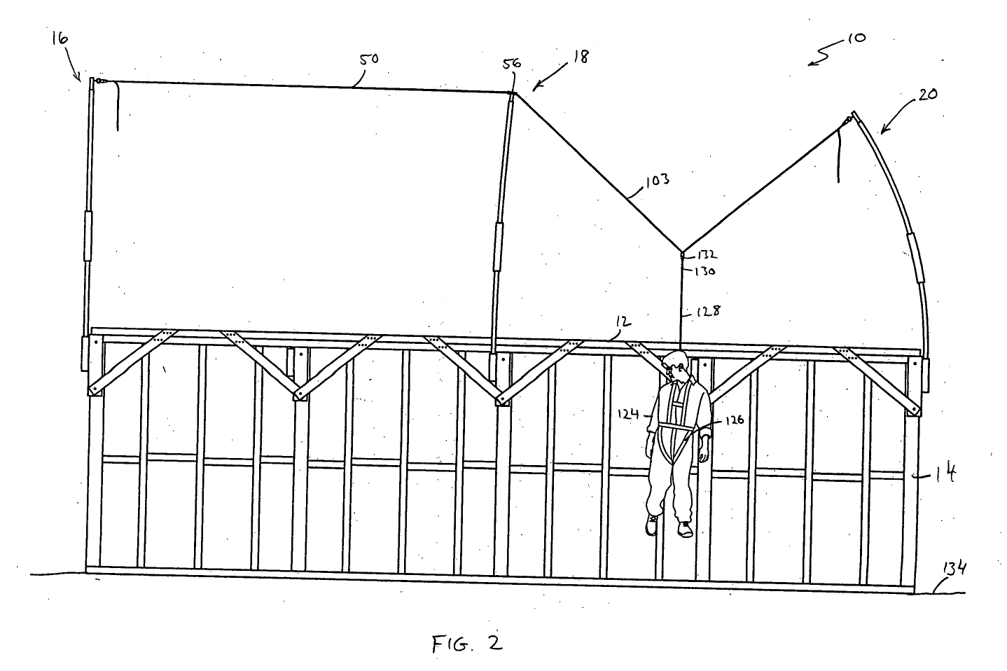

FIGS. 1 and 2, depict an embodiment of a fall-protection system 10 according to the present invention, which is coupled to a top 12 of a wood frame structure 14 that is under construction. The fall-protection system includes a first bracket-pole assembly 16, a second bracket-pole assembly 18, and third bracket-pole assembly 20, all of which are secured to the top of the frame.

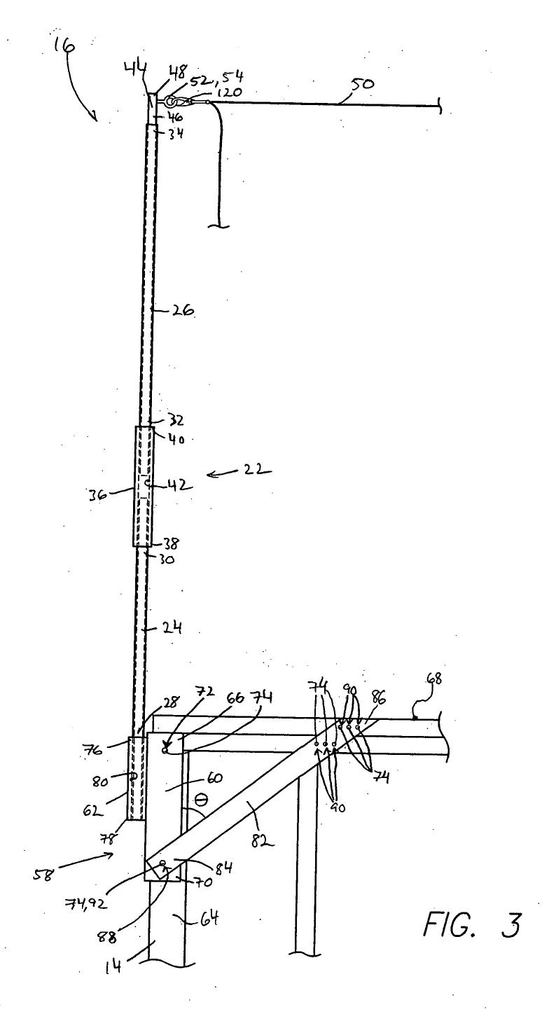

Referring additionally to FIG. 3, each bracket-pole assembly 16-20 includes a pole assembly 22 having a bottom pole 24 and a top pole 26, each having opposite ends 28,30 and 32,34, respectively. Each of the bottom and top poles are approximately 46 inches to approximately 59 inches in length, and approximately 1½ inches to approximately 2½ inches in width. A first end 30 of the bottom pole is coupled to a first end 32 of the top pole using a sleeve 36 having opposite ends 38 and 40. The sleeve is approximately 16 inches in length, and approximately 2/2 inches in width. The first end of the bottom pole inserts into a first end of the sleeve, and the first end 38 of the top pole inserts into a second end 40 of the sleeve.

Preferably, the bottom and top poles 24 and 26, respectively, are hollow tubes, however, they can be solid. Furthermore, the bottom and top poles can be of any cross-sectional geometry, e.g., circular, elliptical, square, or rectangular. Since the bottom and top poles interface with the sleeve 36, the geometry of the interior surface 42 of the sleeve is configured to accommodate the geometry of the first ends 30 and 32 of the bottom and top poles, respectively. It is preferred that the top and bottom poles and the sleeve are made of metal, e.g., steel.

After the first ends 30 and 32 of the bottom and top poles 24 and 26, respectively, are inserted into the opposite ends 38 and 40, respectively, of the sleeve 36, the bottom and top poles can be secured to the sleeve in various manners. For example, in one embodiment, the bottom pole and the top pole are welded to the sleeve. In another example embodiment, the first ends of the bottom and top poles are threaded and the interior surface 42 of the sleeve is tapped so that the first ends of the bottom and top poles can be screwed into the sleeve, thus, securing the first ends of the bottom and top poles to the sleeve. In yet another example embodiment, the first ends of the bottom and top poles are tapered, so they insert into the sleeve only up to a certain distance. In this example embodiment, additional bonding, e.g., welding, of the bottom and top poles to the sleeve need not be required because the tapered first ends of the bottom and top poles securely interface with the sleeve. In yet another example embodiment, a latching mechanism (not shown) is used to secure the first ends of the bottom and top poles to the sleeve.

A cable-securing post 44, having opposite ends 46 and 48, is coupled to the second end 34 of the top pole 26. In preferred embodiments, the cable-securing post is approximately 2½ inches to approximately 6 inches in length, and approximately 1½ inches in width. It is preferred that the cable-securing post is made of metal, e.g., steel.

In the preferred embodiment depicted in FIG. 3, the top pole's second end 34 is hollow, and the first end 46 of the cable-securing post 44 is inserted into the top pole's second end. In additional example embodiments, the first end of the cable-securing post is configured to slip over the top pole's second end. Thus, in example embodiments, the geometries of the top pole's second end and the cable-securing post's first end are designed to interface with one another. As discussed above, in reference to the interface between the first ends 30 and 32 of the bottom and top poles 24 and 26, respectively, and the sleeve 36, the cable-securing post can be secured to the top pole's second end in one of several different ways, e.g., welding, a sliding interface, and a latching mechanism (not shown). Furthermore, the cross-sectional geometry of the cable-securing post can be one of various shapes, e.g., circular, elliptical, square, or rectangular. Additionally, the cable-securing post can be solid or hollow.

Accordingly, when the pole assembly 22 is fully configured, the bottom and top poles 24 and 26, respectively, are coupled to the sleeve 36, in such a manner that the first ends 30 and 32, respectively, of the bottom and top poles interface with the sleeve, and the cable-securing post 44 is coupled to the top pole's second end 34. In preferred embodiments, the overall length of the pole assembly, from the top of the cable-securing post to the second end 28 of the bottom pole is approximately 108 inches in length.

The second end 48 of the cable-securing post 44 is configured to interface with at least one cable 50. In preferred embodiments, the cable-securing post's second end 48 includes an interface piece 52, for example, an eyelet 54 that interfaces with the cable. In additional embodiments, the cable-securing post's second end includes a hook (not shown) configured to interface with the cable. Furthermore, embodiments of the cable-securing post's second end can include more than one eyelet or hook to facilitate the coupling of more than one cable to the cable-securing post.

In additional embodiments, the second end 48 of the cable-securing post 44 includes a tube 56 through which the cable 50 is inserted, as illustrated in FIGS. 1 and 2. In this embodiment, the cable is allowed to slidingly interface with the cable-securing post's tube.

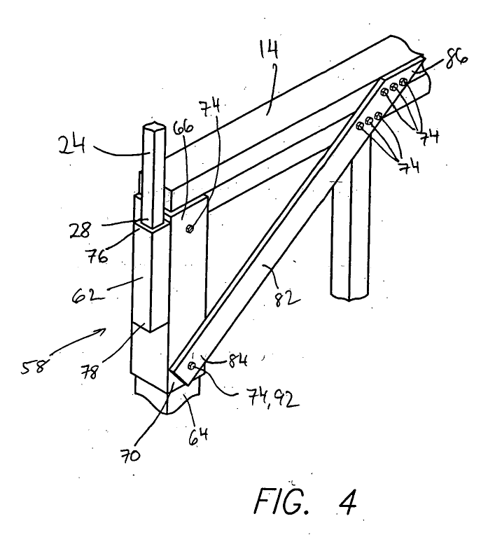

Referring again to FIG. 3, and additionally to FIG. 4, each bracket-pole assembly 16 includes a bracket assembly 58 having a bracket 60 and a bracket tube 62, which is configured to receive the bottom pole's second end 28. The bracket is generally L-shaped in cross section and configured to receive one of the wood frame's post 64. In preferred embodiments, the bracket is approximately 24 inches in length, and has a thickness of approximately ¼ inch.

The bracket 60 has a first end 66 that, when the bracket assembly 58 is installed on the frame 14, is positioned near the frame's top surface 68. The opposite end 70 of the bracket, the bracket's second end, is positioned away from the frame's top surface. The bracket includes a first hole 72 located near the bracket's first end, and a second hole (not shown) located near the bracket's second end. Fastening devices 74, e.g., lag screws and/or nails, are inserted through the bracket's first and second holes, and are used to secure the bracket to the frame's post 64.

The bracket tube 62 includes a first end 76 and an opposite second end 78. The bracket tube is coupled to the bracket 60 such that the bracket tube's first end is located adjacent to the bracket's first end 66. It is preferred that the bracket and bracket tube are made of metal, e.g., steel. Also, in preferred embodiments, the bracket tube is welded to the bracket.

As discussed previously, the bracket tube 62 is configured to receive the bottom pole's second end 28, and as such, the geometry of an inner surface 80 of the bracket tube is configured to accommodate the geometry of bottom pole's second end. Accordingly, the bracket tube's cross-sectional geometry can be, for example, round, elliptical, square, or rectangular. In the preferred embodiment, the bottom pole's second end is tapered and inserts into the bracket tube until the bottom pole 24 can no longer be pushed any further into the bracket tube.

The bracket assembly 58 also includes at least one bracket strap 82, which preferably has a rectangular cross section. In preferred embodiments, the bracket strap is approximately 36 inches in length, approximately 2½ inches in width, approximately ¼ inch in thickness, and made of metal, e.g., steel. The bracket strap has a first end 84 and an opposite second end 86. The first end of the bracket strap is coupled to the second end 70 of the bracket 60. When the bracket assembly is coupled to the frame 14, the bracket strap's second end is coupled to the frame adjacent to the frame's top surface 68. Preferably the bracket strap's second end is tapered so as to interface with the frame's top surface in a flush manner, when the bracket strap is positioned at an angle θ, e.g., approximately 45 degrees to approximately 70 degrees, to the bracket.

The bracket strap 82 includes a first hole 88 near the bracket strap's first end 84, and a plurality of additional holes 90 located near the bracket strap's second end 86. Fastening devices 74, e.g., lag screws and/or nails, are inserted through the bracket strap's plurality of additional holes, and are used to secure the bracket strap's second end to the frame 14. As shown in FIG. 4, the fastening device 92 that is inserted through the bracket's second hole (not shown) is also inserted through the bracket strap's first hole.

Referring again to FIGS. 1 and 2, a bracket assembly 58 can include more than one bracket strap 82, for example, the second bracket-pole assembly 18 includes two bracket straps. When the bracket assembly includes more than one bracket strap, the additional bracket strap 94 includes a first end 96, which is coupled to the bracket's second end 70, and a second end 98, which is coupled to the frame 14 adjacent to the frame's top surface 68 on the opposite side of the bracket 60 from the second end 86 of the first bracket strap 82.

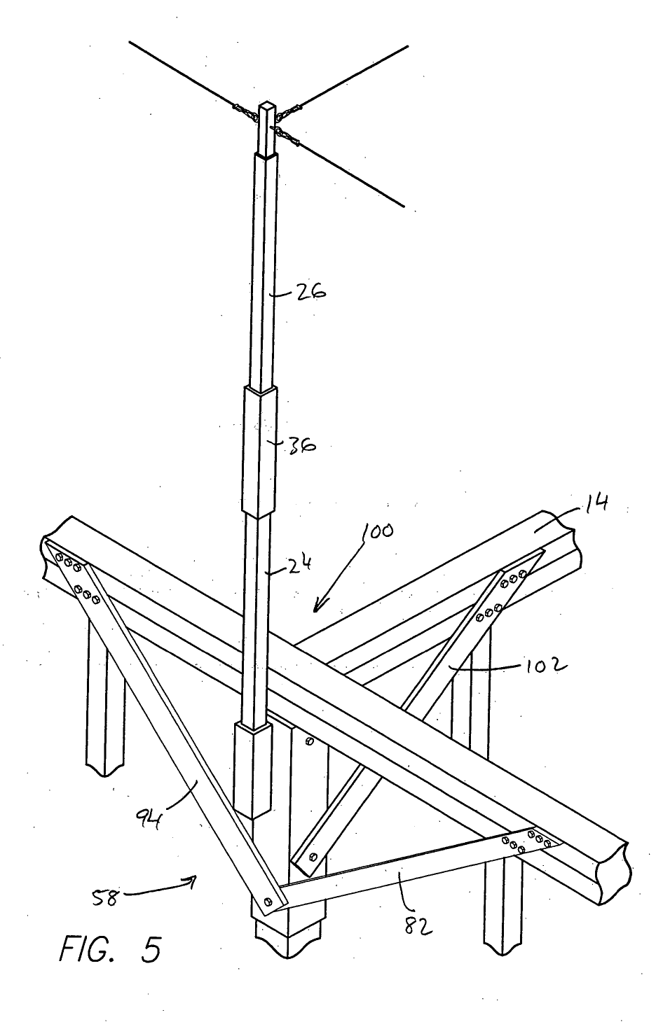

Referring additionally to FIG. 5, when a bracket assembly 58 is coupled to a frame 14 at a T-interface 100, or three-way interface, the bracket assembly can include three bracket straps 82, 94, and 102. Similarly, when a bracket assembly is coupled to a frame at a four-way interface (not shown), the bracket assembly can include four bracket straps (not shown).

When the fall-protection system 10 is fully configured, the bracket 60 is secured to a post 64 with fastening devices 74, as previously discussed, and at least one bracket strap 82 is coupled to both the bracket and the frame 14. Next, a pole assembly 22 is coupled to the bracket assembly 58, with the bottom pole's second end 28 inserted into the bracket tube 62. The bracket strap provides additional lateral support for the bracket, and thus, compensates for lateral forces exerted on the bracket by the pole assembly. When the bracket assembly includes one or more additional bracket straps 94 and 102, the additional bracket strap(s) provide added compensation for lateral forces applied to the bracket by the pole assembly.

Referring again to FIGS. 1 and 2, a first cable 50 is coupled between the cable-securing posts 44 and 56 of the first and second bracket-pole assemblies 16 and 18, respectively, and a second cable 103 is coupled between the cable-securing posts 56 and 104 of the second and third bracket-pole assemblies 18 and 20, respectively. The first and second cables can be made of various materials, e.g., steel. Typically, the first and second cables are approximately 20 feet in length, and the cables are approximately ½ inch to approximately 5/16 inch in diameter. While three bracket-pole assemblies 16-20 and two cables 50 and 103 are shown in FIGS. 1 and 2, additional embodiments of the fall-protection system 10 can include additional, or fewer, bracket-pole assemblies and interconnecting cables.

Each of the cables 50 and 103 has a first end 106 and 110, respectively, and an opposite second end 108 and 112, respectively. When the cable-securing posts 44, 56, and 104 include either eyelets 54 or hooks (not shown), the first and second ends of the cables are connected to the tops 114-118 of the bracket-pole assemblies 16-20, respectively, using clips 120. In the case where a cable-securing posts include a hook, the end of the cable that interface with the hook can include a loop (not shown) that slips over the hook. In the embodiment shown in FIGS. 1 and 2, the second bracket-pole assembly's cable-securing post includes a hollow tube 56, through which the cable 50, 103 is inserted. The opposite ends 106 and 112 of the cable are secured to the cable-securing posts of the first bracket-pole assembly and the second bracket-pole assembly.

The fall-protection system 10 can include one or more additional bracket assemblies 122 that are coupled to the top 12 of the frame 14. These additional bracket assemblies advantageously provide additional locations into which a pole assembly 22 can be secured. Thus, if a need exists to reposition a pole assembly during construction, the pole assembly can be moved from its current bracket assembly to an additional bracket assembly.

During assembly of the fall-protection system 10, bracket assemblies 58 are mounted to the top 12 of the frame 14 with each bracket 60 coupled to a frame post 64, and one or more bracket straps 82, 94, and 102 coupled between the bracket and the frame. Next, the pole assemblies 22 are assembled such that each pole assembly's sleeve 36 couples a bottom pole 24 to a top pole 26. Next, the second end 28 of each pole assembly's bottom pole is inserted into, and coupled to, a bracket tube 62 included in one of the bracket assemblies. Cable-securing posts 44, 56, and 104 are coupled to the second end 34 of each pole assembly's top pole. Finally, cables 50 and 103 are coupled between the cable-securing posts.

After the fall-protection system 10 has been completely installed on top 12 of the frame 14, a person 124, e.g., construction worker, standing on top of the frame and wearing a harness 126 would secure himself or herself to the fall-protection system by coupling one end (not shown) of a lanyard 128 to the harness and an opposite end 130 of the lanyard to one of the cables 50 and 103, respectively. The opposite end 130 of the lanyard is slidingly coupled to the cable. A clip 132 can be used to couple the opposite end of the lanyard to the cable.

The fall-protection system 10 is configured to allow the construction worker 124 to move along the top 12 of the frame 14. As the construction worker moves along the top of the frame, the opposite end 130 of the lanyard 128 slides along one of the cables 50 and 103. If need be, the construction worker easily can decouple the lanyard from the one cable, and can either get down from the top of the frame, for example, by using a ladder (not shown), or can recouple the lanyard to another cable and continue to move along the top of the frame.

FIG. 2 illustrates a situation where a construction worker 124, who is coupled to the fall-protection system 10 has fallen from the top 12 of the frame 14. As shown in FIG. 2, the construction worker's weight has pulled the second cable 102 down, and the second and third bracket-pole assemblies 18 and 20, respectively, have flexed toward the suspended construction worker. However, the worker did not hit the ground 134. The flexing of the pole assemblies creates a more gradual deceleration for the suspended construction worker.

Because the fall-protection system 10 allows the construction worker 124 to fall only a limited distance from the top 12 of the frame 14, the fall-protection system advantageously minimizes the likelihood of a construction worker receiving injuries resulting from an impact with the ground 134. In addition to preventing injury that could result from a construction worker's fall from the top of the frame, the fall-protection system is assembled quickly and easily, occupies little volume, and is less costly than scaffolding (not shown). Additionally, the fall-protection system couples directly to the construction worker, thus preventing errant construction worker falls that can occur even if scaffolding is installed at the construction site.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

1. A fall-protection system configured to couple to a frame and a person, the fall-protection system comprising:
a first bracket-pole assembly that is configured to couple to the frame;
a second bracket-pole assembly that is configured to couple to the frame;
a cable that is configured to couple between the first bracket-pole assembly and the second bracket-pole assembly; and
a lanyard having a first end that is configured to couple to the person and a second end that is configured to slidingly couple to the cable.

2. The fall-protection system according to claim 1, wherein each of the first bracket-pole assembly and the second bracket-pole assembly includes:
a bracket assembly that is configured to couple to the frame; and
a pole assembly that is configured to interface with the bracket assembly.

3. The fall-protection system according to claim 2, wherein the bracket assembly includes:
a bracket that is configured to couple to the frame; and
a bracket tube that is coupled to the bracket and that is configured to interface with the pole assembly.

4. The fall-protection system according to claim 3, wherein the bracket is coupled to the frame using a fastening device selected from the group consisting of a screw and a nail.

5. The fall-protection system according to claim 3, wherein the bracket tube is welded to the bracket.

6. The fall-protection system according to claim 3, wherein the bracket assembly further includes a bracket strap having:
a first end that is configured to couple to the bracket; and
a second end that is configured to couple to the frame.

7. The fall-protection system according to claim 6, wherein the bracket, bracket tube, and bracket strap are made of steel.

8. The fall-protection system according to claim 6, wherein the bracket strap is coupled to the frame and the bracket using fastening devices selected from the group consisting of screws and nails.

9. The fall-protection system according to claim 2, wherein the pole assembly includes:
a top pole having a first end and a second end;
a bottom pole having a first end and a second end; and
a sleeve that is configured to interface with both the top pole's first end and the bottom pole's first end.

10. The fall-protection system according to claim 9, wherein the sleeve is coupled to both the top pole and the bottom pole by a method selected from the group consisting of bonding, welding, screwing, and latching.

11. The fall-protection system according to claim 9, wherein the pole assembly further includes a cable-securing post that is coupled to the top pole's second end.

12. The fall-protection system according to claim 11, wherein the top pole, the bottom pole, the sleeve, and the cable-securing post are made of steel.

13. The fall-protection system according to claim 11, wherein the cable couples to the cable-securing post.

14. The fall-protection system according to claim 13, wherein the cable-securing post includes an interface piece configured to interface with the cable.

15. The fall-protection system according to claim 14, wherein the interface piece is selected from the group consisting of an eyelet, a hook, and a tube.

16. The fall-protection system according to claim 14, wherein:
the cable has a first end and a second end;
the cable's first end includes a first loop; and
the cable's second end includes a second loop;
wherein the cable's first and second ends are configured to interface with the interface piece.

17. The fall-protection system according to claim 14, wherein:
the cable has a first end and a second end;
a first clip is coupled to the cable's first end; and
a second clip is coupled to the cable's second end;
wherein the first clip and the second clip are configured to interface with the interface piece.

18. The fall-protection system according to claim 1, wherein the cable is made of steel.

19. The fall-protection system according to claim 1, further comprising a harness configured to be worn by the person, wherein the lanyard is coupled between the harness and the cable.

20. A bracket-pole assembly configured to couple to a frame, the bracket-pole assembly comprising:
a bracket assembly including:
a bracket that is configured to couple to the frame, and
a bracket tube that is coupled to the bracket; and
a pole assembly including:
a top pole having a first end and a second end,
a bottom pole having a first end and a second end, wherein the bottom pole's second end is configured to interface with the bracket tube, and
a sleeve that is configured to interface with both the top pole's first end and the bottom pole's first end.

21. The bracket-pole assembly according to claim 20, further comprising a bracket strap that is configured to couple between the bracket and the frame.

22. The bracket-pole assembly according to claim 20, further comprising a cable-securing post that is coupled to the top pole's second end and that includes an interface piece.

23. A method for installing a fall-protection system on a frame and coupling a person to the fall-protection system, the method comprising:
providing a first bracket assembly;
providing a second bracket assembly;
providing a first pole assembly having a first end and a second end;
providing a second pole assembly having a first end and a second end;
providing a cable;
providing a lanyard having a first end and a second end;
coupling the first bracket assembly to the frame;
coupling the second bracket assembly to the frame;
interfacing the first pole assembly's first end with the first bracket assembly;
interfacing the second pole assembly's first end with the second bracket assembly;
coupling the cable between the second ends of the first and second pole assemblies;
coupling the lanyard's first end to the person; and
coupling the lanyard's second end to the cable.

24. The method according to claim 23, wherein the first bracket assembly and the second bracket assembly each include a bracket strap having a first end and a second end, a bracket, and a bracket tube coupled to the bracket, and further comprising:
coupling the bracket to the frame;
coupling the bracket strap's first end to the bracket; and
coupling the bracket strap's second end to the frame.

25. The method according to claim 23, wherein the first pole assembly and the second pole assembly each include a top pole, a bottom pole, and a sleeve having a first end and a second end, and further comprising:
coupling the sleeve's first end to the top pole; and
coupling the sleeve's second end to the bottom pole.
